(19) United States
(12) Patent Application Publication
(10) Pub. No.: US 2015/0047519 A2
(43) Pub. Date: Feb. 19, 2015

(54) METHOD AND DEVICE FOR CONTROLLING THE POSITION OF THE NUMBERING WHEELS OF A NUMBERING DEVICE

(71) Applicants: Carsten Diederichs, Lemgo (DE); Stefan Bless, Detmold (DE)

(72) Inventors: Carsten Diederichs, Lemgo (DE); Stefan Bless, Detmold (DE)

(73) Assignee: KBA-NotaSys SA, Lausanne 22 (CH)

(21) Appl. No.: 12/310,112

(22) PCT Filed: Aug. 17, 2007
(86) PCT No.: PCT/IB2007/053279

§ 371 Date: Feb. 11, 2009

(30) Foreign Application Priority Data
Aug. 22, 2006 (EP) 06119315.7

(51) Int. Cl. G06K 1/12; B41J 7/48

(52) U.S. Cl. 101/93.01; 101/99

(57) ABSTRACT

There is described a method for controlling the position of numbering wheels (7) of a numbering device (1), which numbering device (1) is of the type comprising a plurality of independently-driven numbering wheels (7) disposed adjacent to one another for rotation about a common rotation axis, the method comprising actuating the numbering wheels (7) between successive numbering iterations, whereby each numbering wheel (7) which has to be rotated to a new target position is driven into rotation until it reaches its new target position. The method further comprises, at least during actuation of the numbering wheels (7), compensating for external factors acting on the numbering wheels (7), such as friction induced by adjacent rotating numbering wheels, by electronically regulating the position of each numbering wheel (7) which is not rotated or which has reached its new target position. Also described is a device for carrying out this method.

### TECHNICAL FIELD

The present invention generally relates to a method and device for controlling the position of numbering wheels of a numbering device as used in printing presses for carrying out numbering of printed documents, especially banknotes and the like securities.

More precisely, the present invention relates to a method and device for controlling the position of numbering wheels of a numbering device of the type comprising a plurality of independently-driven numbering wheels disposed adjacent to one another for rotation about a common rotation axis, the method comprising actuating the numbering wheels between successive numbering iterations, whereby each numbering wheel which has to be rotated to a new target position is driven into rotation until it reaches its new target position.

### BACKGROUND OF THE INVENTION

In the art of printing of securities, such as banknotes, checks and other similar objects, an important feature which is printed on said securities is a serial number. In particular, each printed banknote typically receives a unique combination of numbers and characters building the serial number of the banknote.

Securities, especially banknotes, are usually printed in the form of arrays on successive sheets or successive portions of a continuous web, which sheets or web portions are then preferably fed to a numbering press where all the printed positions are numbered in one pass. Stacks of such numbered sheets or web portions are ultimately cut into individual banknotes at the end of the printing process so as to typically form bundles of individual security documents.

Numbering presses are commonly provided with numbering devices each comprising several typographic numbering wheels (or disks) having alpha-numerical symbols engraved in relief on their circumference, which numbering wheels are disposed adjacent one another for rotation about a common rotation axis. Depending on the configuration of the numbering devices, actuation thereof may be performed according to only one or various numbering processes, which numbering processes are for instance described in U.S. Pat. No. 4,677,910, European patent application No. EP 0 598 679, or International application No. WO 2004/016433.

International application No. WO 2004/016433, which is incorporated herein by reference, discloses a particularly advantageous numbering approach wherein sheets or web portions are numbered so that all bundles derived from a given stack of numbered sheets or web portions (usually hundred consecutive sheets or web portions) correspond to one complete consecutive numerical sequence, i.e. a stack of sheets with M×N security prints yields M×N bundles numbered in sequence, that is M×N×100 security papers numbered in sequence. This numbering scheme thus enables so-called non-collating processing of stacks of sheets or web portions, i.e. building of complete sets of bundles of security documents numbered in sequence without this requiring a specific bundle collating process to temporarily store and assemble the bundles in the correct sequence.

Usual mechanically-actuated numbering devices can only be actuated in a sequential manner and require specific mechanical actuating means. Such numbering devices cannot implement the numbering approach of WO 2004/016433, unless constraints as regards the number of prints per sheet or web portion are met. This is possible only when the number of security prints on each sheet is a multiple of ten (or of twenty-five) and by designing the numbering devices in a specific manner. One such solution is disclosed in International application No. WO 2005/018945. Another alternate solution is disclosed in European patent application No. EP 1 731 324 (corresponding to WO 2006/131839) in the name of the present Applicant. Such solutions are not applicable to cases where sheets comprise a number of security prints that is not a multiple of ten or of twenty-five.

Other than the above-mentioned examples of mechanically-actuated numbering devices, the numbering approach of WO 2004/016433 requires numbering devices that are entirely flexible as to the way the numbering wheels can be actuated from one numbering iteration to the next.

A numbering device with freely adjustable numbering wheels is disclosed for example in U.S. Pat. No. 5,660,106. This patent discloses a numbering device wherein all the numbering wheels are rotatable about a common driving shaft and are driveable by a slip coupling with the driving shaft and wherein electro-magnetically-actuated pawls are provided to selectively block any one of the numbering wheels in the desired target position. This numbering device has the advantage that selectively and arbitrary, even non-sequential, numbers can be formed at any time, allowing in particular a non-unitary skip of numbers from one numbering iteration to the next. This numbering device can in particular be used to implement the numbering scheme disclosed in WO 2004/016433. For a detailed explanation of the functioning of this numbering device, reference is made to the entire disclosure of U.S. Pat. No. 5,660,106. Disadvantages of this numbering device however reside in the relatively complex actuation mechanism and related costs, as well as in the build-up of excessive heat caused by friction between the numbering wheels and the common driving shaft.

A somewhat similar but more complicated numbering device than that described in U.S. Pat. No. 5,660,106 is disclosed in German patent application No. DE 30 47 390. One disadvantage thereof resides in the fact that it is slow and only allows rotation of the numbering wheels in one direction.

A hybrid numbering device is disclosed in International application WO 2004/016433, already mentioned hereinabove. In this numbering device, the wheels for the unit digits and ten digits are actuated in a sequential manner (i.e. by purely mechanical actuation means), whereas at least the wheels for the hundred and thousand digits are actuated in an independent manner to allow the skipping of numbers during numbering. This construction allows to carry out the specific numbering process mentioned hereinabove which enables non-collated processing of the bundles.

A disadvantage of the numbering devices described in U.S. Pat. No. 5,660,106, DE 30 47 390, WO 2004/016433, WO 2005/018945, and EP 1 731 324, mentioned hereinabove, resides in the fact that, as with conventional mechanical numbering devices, the numbering devices mechanically interact with actuation means that are not part of the numbering devices per se and which are typically mounted on the numbering machine where the numbering device are disposed. In particular, each numbering device requires an actuation cam member for actuating or at least releasing the numbering wheels, which cam member cooperates with a corresponding cam surface placed in the numbering press. In some of the proposed solutions, driving into rotation of the numbering wheels further requires a mechanical coupling, such as the solution described in U.S. Pat. No. 5,660,106 which necessitates a driving gear wheel and an associated toothed segment.

In addition, in all of the above prior art solution, mechanical indexing means are provided in order to stop each numbering wheel individually once it is positioned to the desired target position. These indexing means are usually designed as ratchet mechanisms whereby a mechanical piece interacts with a ratchet provided on each wheel. During actuation, a releasing mechanism is actuated in order to release the ratchets and enable rotation of the numbering wheels.

U.S. Pat. No. 4,843,959 discloses, with reference to FIGS. 3 to 6 thereof, another hybrid numbering device in which six numbering wheels out of ten (that is the numbering wheels for the units, tens, hundreds, thousands, ten thousands and hundred thousands) are all driven by respective stepping motors through gearings and shafts. Each motor incorporates a position sensing device, e.g. a shaft encoder for proper control of the operation of the motors, and feedback from the sensing devices to a computer enables the computer to verify the settings of the numbering wheels. The remaining four numbering wheels carry the individual indicia for the prefixes or suffixes, and no description is given regarding the means used to drive said wheels.

A mechanically-autonomous electronic numbering device, which does not at all require any mechanical actuation means for actuation of the numbering wheels, is disclosed in European patent application No. 06115994.3 filed on Jun. 23, 2006 and No. 06124403.4 filed on Nov. 20, 2006 in the name of the present Applicant and entitled “NUMBERING DEVICE FOR TYPOGRAPHIC NUMBERING” (see also PCT application No. PCT/IB2007/052366 filed on Jun. 20, 2007 which claims priority of the above two European patent applications), the content of which is incorporated herein by reference in its entirety. FIGS. 1 and 2 attached hereto show perspective views of one embodiment of the numbering device disclosed in European patent application No. 06115994.3 and which will be briefly discussed in the following, further embodiments being envisaged in European patent applications No. 06115994.3 and No. 06124403.4 (as well as in PCT application No. PCT/IB2007/052366).

A particularity of this numbering device resides in that each numbering wheel of the numbering device is driven into rotation by its own independent drive mechanism and can be set to any desired position independently from the other numbering wheels. This particularity requires that the position of the numbering wheels be controlled during actuation so as to ensure that the wheels are moved to the appropriate target positions before the subsequent numbering iteration. A wholly new control and actuation approach had to be conceived for this purpose, which approach forms the subject-matter of the present application.

### SUMMARY OF THE INVENTION

An aim of the invention is to improve the known numbering devices and method of controlling thereof.

In particular, an aim of the present invention is to provide a method and device for controlling the position of the numbering wheels of a numbering device of the above-mentioned type with independently-driven numbering wheels, which method and device ensure a robust and correct operation of the numbering device.

Another aim of the present invention is to provide such a method and device which enable fast actuation and precise control of the target positions of the numbering wheels.

Still another aim of the present invention is to provide such a method and device which ensure that each numbering wheel is positioned at the end of the actuation process in the correct target position and ensures that external factors, such as friction with neighbouring rotating wheels, do not affect the preciseness or correctness of this target position.

Yet another aim of the present invention is to provide such a method and device which are efficient from the point of view of energy consumption or constraints applied onto the driving means used to actuate the numbering wheels.

These aims are achieved thanks to the method and device defined in the claims.

There is accordingly provided a method for controlling the position of numbering wheels of a numbering device, which numbering device is of the type comprising a plurality of independently-driven numbering wheels disposed adjacent to one another for rotation about a common rotation axis, the method comprising actuating the numbering wheels between successive numbering iterations, whereby each numbering wheel which has to be rotated to a new target position is driven into rotation until it reaches its new target position. According to the invention, the method further comprises, at least during actuation of the numbering wheels, compensating for external factors acting on the numbering wheels by electronically regulating the position of each numbering wheel which is not rotated or which has reached its new target position.

There is similarly provided a device for controlling the position of numbering wheels of a numbering device, which numbering device is of the type comprising a plurality of independently-driven numbering wheels disposed adjacent to one another for rotation about a common rotation axis, the device comprising actuation means for actuating the numbering wheels of the numbering device between successive numbering iterations, whereby each numbering wheel which has to be rotated to a new target position is driven into rotation until it reaches its new target position. This device further comprises an electronic regulation unit for compensating for external factors acting on the numbering wheels, at least during actuation of the numbering wheels, by electronically regulating the position of each numbering wheel which is not rotated or which has reached its new target position.

In the following one shall understand that the expression “external factors” refers to any external factor interfering with the actuation of the numbering wheels and that could lead to a change of the desired positions of the numbering wheels. This in particular includes friction caused by a neighbouring rotating numbering wheel which will have a tendency to draw an adjacent non-rotating numbering wheel with it and modify its position. This also includes perturbations which could be caused by other elements contacting the circumference of a numbering wheel.

Preferably, the electronic regulation of the position of each numbering wheel includes monitoring the position of the numbering wheel and correcting the position of the numbering wheel to return to its desired position.

According to an aspect of the invention, actuation of the numbering wheels includes (i) a first phase during which an actuated numbering wheel is accelerated, (ii) a second phase during which the actuated numbering wheel is driven at a substantially constant speed, and (iii) a third phase during which the actuated numbering wheel is decelerated before reaching the target position. Preferably, actuation of the numbering wheels further includes (iv) a fourth phase during which the actuated numbering wheel is driven at a low speed until determined actuation parameters preceding complete standstill of the actuated numbering wheel are reached, and (v) a fifth phase during which the actuated numbering wheel is brought to complete standstill according to a predetermined deceleration sequence. This latter five-phase actuation principle is preferred in that it permits to ensure that each actuated numbering wheel will come to standstill exactly at the target location, not before or after.

According to another aspect of the invention, each numbering wheel is driven into rotation by an electric motor (preferably a brush-less DC motor with electronic commutation) having a plurality of steps per revolution and actuation of a numbering wheel to a target position comprises (i) determining a number of steps required for the numbering wheel to reach the target position from its current position, and (ii) driving the numbering wheel into rotation for the determined number of steps in a given time. In this context, determination of the number of steps required for the numbering wheel to reach the target position from its current position can be based on a predetermined lookup table.

In the context of the above step-by-step actuation, the number of steps required for the numbering wheel to reach the target position from its current position is advantageously a multiple of a given number of steps corresponding to an angular displacement of the numbering wheel of 360°/s, where s designates the number of numbering segments of the numbering wheel.

In a preferred embodiment, the actuation method comprises the step of determining, for each numbering wheel to be actuated, a shortest way to the target position, which shortest way correspond to an angular displacement of the numbering wheel of 180° or less.

Still according to another embodiment, the method further comprises, once all actuated numbering wheels have reached their target positions, activating a mechanical indexing mechanism for mechanically locking the position of all numbering wheels and stopping the electronic regulation of the position of the numbering wheels until a subsequent actuation is carried out. This mechanical indexing mechanism is preferably activated during an inking operation of the numbering wheels and during a printing operation.

Further advantageous embodiments of the invention are the subject-matter of the dependent claims.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 shows a general perspective view of an embodiment of a numbering device with independently-driven numbering wheels;

FIG. 2 shows another perspective view of the embodiment of FIG. 1 where part of the gearings used to drive the numbering wheels into rotation are apparent;

FIG. 3 is a schematic view of the kinematic driving chain between a numbering wheel and its associated driving means;

FIGS. 4a, 4b and 4c are views illustrating an embodiment of a releasable indexing mechanism for mechanically aligning and maintaining the position of the numbering wheels;

FIG. 5 is a schematic drawing of two possible connection modes of the three partial winding of an electric motor used to drive the associated numbering wheel according to one embodiment of the invention;

FIG. 6 is a schematic diagram of switch combinations detected by built-in sensors of the electric motor used to drive an associated numbering wheel into rotation;

FIG. 7 is a schematic diagram illustrating how the partial windings of FIG. 5 are supplied; and

FIG. 8 is a diagram showing a complete actuation phase of a numbering wheel to reach its intended target position according to a preferred embodiment of the invention.

### DETAILED DESCRIPTION OF EMBODIMENTS OF THE INVENTION

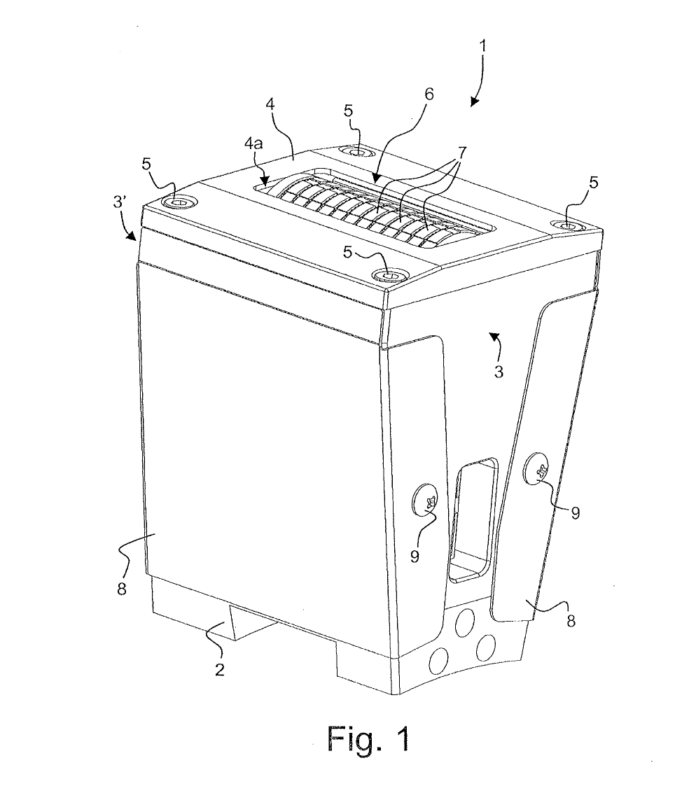

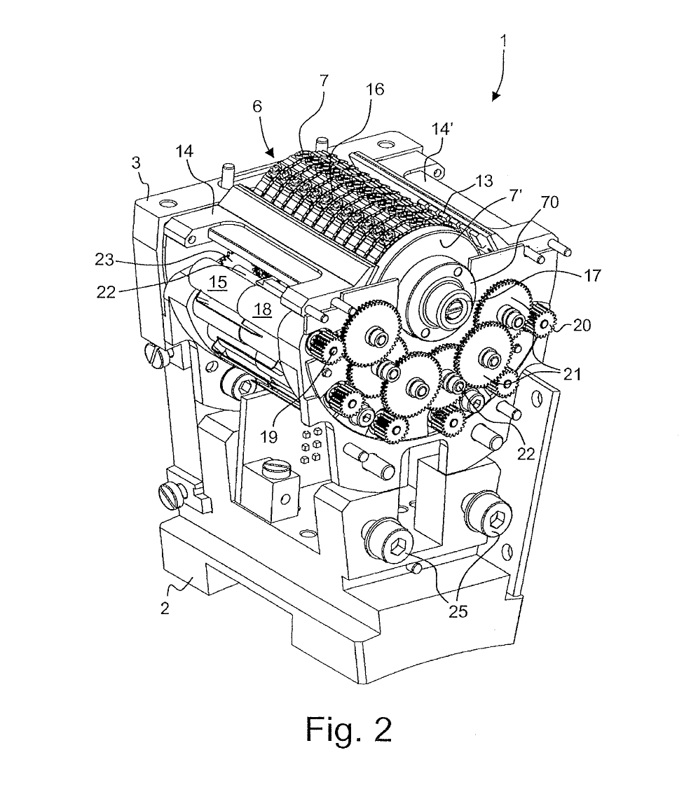

As already mentioned hereinabove, FIGS. 1 and 2 show perspective views of one embodiment of the numbering device disclosed in European patent application No. 06115994.3 filed on Jun. 23, 2006 in the name of the present Applicant and entitled “NUMBERING DEVICE FOR TYPOGRAPHIC NUMBERING”.

The numbering device of FIGS. 1 and 2, designated generally by reference numeral 1, comprises a casing with a bottom frame part 2 and a two-piece lateral frame part 3, 3′. The two-piece lateral frame part comprises two side frame parts 3 and 3′ (side frame part 3′ being not visible in FIG. 1, while it has been omitted for the purpose of explanation in FIG. 2 which shows the opposite side of the numbering device 1) which are secured at their bottom ends to the bottom frame part 2 by screws 25 (visible in FIG. 2). The upper part of the numbering device 1 is covered by a top cover member 4 (only visible on FIG. 1) which is secured to the side frame parts 3, 3′ through top screws 5. The cover member 4 is provided with an opening 4a through which emerges part of a numbering unit 6 comprising several numbering wheels or disks 7 disposed next to each other for rotation about a common rotation axis.

In this embodiment, the numbering device 1 is also covered on its sides by protective side cover members 8 mounted onto the side frame parts 3, 3′ through side screws 9. While only two side screws 9 are visible in FIG. 1, it shall be appreciated that two other side screws are provided on the opposite side of the numbering device 1 in order to similarly secure the side cover members 8 in position.

In FIG. 2, the two side cover members 8 and the top cover member 4, as well as side frame part 3′ have been omitted in order to better show the arrangement of the components located within the inner space of the numbering device 1. As represented on the top side of the numbering device 1, the numbering unit 6 carries several rotatable numbering wheels 7 disposed next to each other about a common rotation axis. In the illustrated embodiment, the numbering unit 6 comprises twelve numbering wheels 7, and one extra dummy wheel 7′. The purpose of the dummy wheel 7′ is to ensure that the numbering unit 6 exhibits a determined length and symmetry for adequate positioning of the numbering unit 6 between the two side frame parts 3 and 3′. Each numbering wheel 7 carries alpha-numerical symbols such as a series of numbers (typically 0 to 9) and/or a series of letters (for example A, B, C etc). Such symbols are used to number printed securities (as has been explained above in a detailed manner). Besides the above-mentioned symbols, and depending on the application, the numbering wheels 7 may also be provided with a cancellation index for printing a cancellation mark and/or an empty index for not printing any symbol and leaving an empty space during printing. In addition, each numbering wheel 7 carries at least one magnet (not shown) for calibration purposes, each magnet being designed to cooperate with a corresponding detector 13 (for example a Hall effect detector) carried by a supporting member 14, 14′ as disclosed and explained in EP 06115994.3. In the example of FIG. 2, six detectors 13 are carried by supporting member 14′, and six other detectors (not visible in FIG. 2) are carried by supporting member 14 (all twelve detectors 13 might however be disposed on one and a same supporting member). The purpose of the magnets and detectors 13 is to calibrate the position of each numbering wheel 7 about the rotation axis and to ensure that each numbering wheel 7 can be brought to any of the desired numbering positions. Supporting members 14, 14′ are mounted between the side frame parts 3, 3′ and can be rotated backwards from their illustrated positions away from the numbering unit 6 once the top cover member 4 is removed, thereby enabling assembly or disassembly of the numbering unit 6.

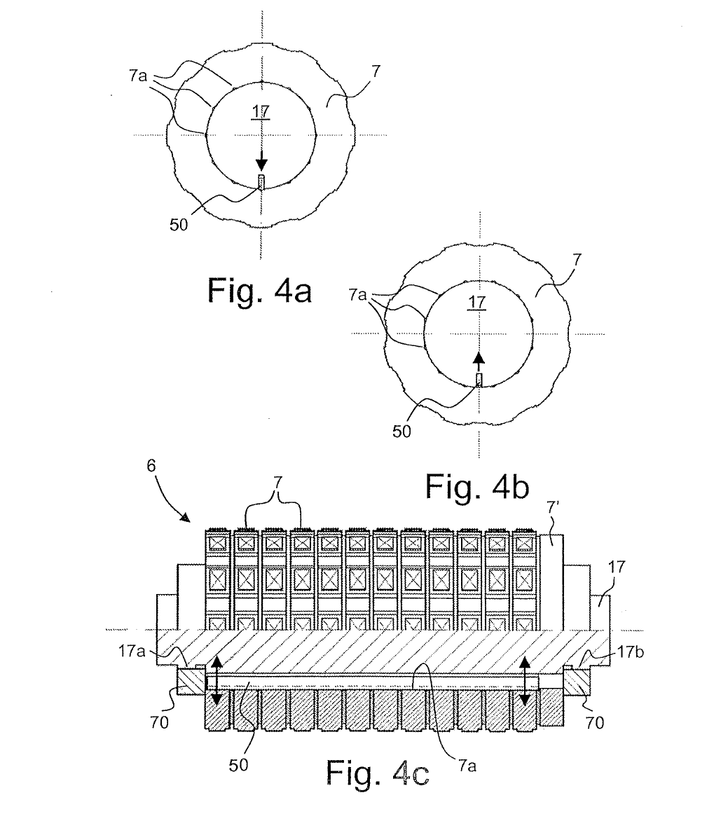

Each numbering wheel 7 is actuated in an independent manner through associated driving means. As illustrated in FIG. 2, the numbering wheels 7 are mounted for rotation about a common shaft 17 which is supported at both ends onto bearings provided in the side frame parts 3 and 3′. The numbering wheels 7 are held onto the common shaft 17, together with the dummy wheel 7′, by a pair of holding rings 70 (only one being visible in FIG. 2), which holding rings 70 are secured to threaded end portions of the common shaft 17 (designated by references 17a and 17b in FIG. 4c). The numbering wheels 7 are mounted such as to be freely rotatable about the common shaft 17 between the holding rings 70. The common shaft 17 does not rotate.

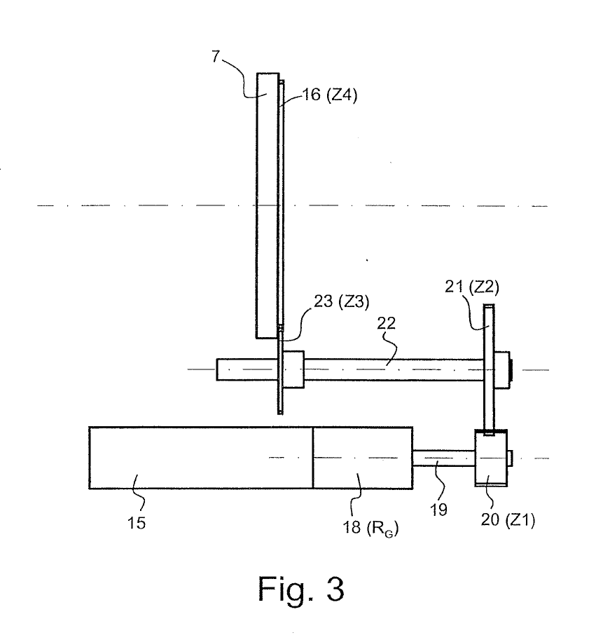

Each said numbering wheel 7 is driven into rotation by an electric motor 15 coupled to a gear-wheel assembly 19, 20, 21, 22, 23 (shown schematically in FIG. 3). To this end, each numbering wheel 7 is provided with a toothed wheel 16 which is designed to rotate together with the numbering wheel 7. Twelve toothed wheels 16 are accordingly present between the numbering wheels 7. In the illustrated embodiment, the actuation means for actuating the numbering wheels 7 thus comprise twelve motors 15, twelve gear-wheel assemblies 19-23 and twelve toothed wheels 16 (i.e. one for each numbering wheel 7). Each motor 15 is preferably associated to a reduction gear 18. The reduction gear 18 has an output shaft 19 carrying a first pinion 20 which meshes with a gear wheel 21 mounted on an intermediate shaft 22, said intermediate shaft 22 being driven into rotation by the gear wheel 21. On the intermediate shaft 22, there is also mounted a second pinion 23 that meshes with the toothed wheel 16 of the corresponding numbering wheel 7. Accordingly, each numbering wheel 7 is driven into rotation by its own independent drive mechanism as described hereabove and can be set to any desired position independently from the other numbering wheels 7.

The gear-wheel assembly 19-23 and associated toothed wheel 16 form a two-stage gearing as schematically illustrated in FIG. 3. This two-stage gearing exhibits a determined reduction factor that depends on the ratios between the number of teeth of the pinions 20, 23, of the gear wheel 21 and of the toothed wheel 16. More precisely, the reduction factor R_{Z} of the two-stage gearing 16, 19-23 is given by the following expression where Z1, Z2, Z3, Z4 are respectively the numbers of teeth of the first pinion 20, of the gear wheel 21, of the second pinion 23 and of the toothed wheel 16:

R_{Z}=(Z2*Z4)/(Z1*Z3) (1)

As mentioned hereinabove, each motor 15 is preferably coupled to the two-stage gearing 16, 19-23 via a reduction gear 18. This reduction gear 18 provides an additional reduction of the output speed and an additional increase of the output torque of the motor 15. The reduction gear 18 also exhibits a reduction factor which will be referred to as R_{G}. The overall reduction factor R between the output of the motor 15 and the associated numbering wheel 7 will thus be given by the following expression:

R=R_{G}*R_{Z}=R_{G}*(Z2*Z4)/(Z1*Z3) (2)

It will be appreciated that if a reduction gear is omitted, the reduction factor R_{G} in expression (2) above can be replaced by the value “one”. The embodiment of the numbering device 1 which is illustrated in FIGS. 1 to 3 was designed with a view to attain at least the following three main objectives:

1. a positional resolution or accuracy of the numbering wheels 7 as high as possible;

2. a commutation time for the numbering wheels 7 to move to the target positions as short as possible;

3. a numbering device as small and compact as possible. The motors 15 and reduction gears 18 are preferably components manufactured and sold by company Maxon Motors AG in Switzerland (www.maxonmotor.com). More precisely, the motors 15 are preferably brush-less DC motors with electronic commutation (also referred to by the acronym BLDC), as manufactured by Maxon Motors AG under reference EC 6, with a rotational speed of several thousands revolutions per minute (rpm), which are particularly well suited to the present application, while the reduction gears 18 are preferably miniature planetary gears, as manufactured by Maxon Motors AG under reference GP 6, both having a diameter of the order of 6 mm. The advantages of using brush-less DC motors with electronic commutation as compared to other types of motors, such as stepping motors, are multiple. First of all, friction and wear problems are limited to a big extent because of the brush-less configuration of such motors, thereby leading to a long life cycle. In addition, such motors can be miniaturized to a substantial extent while still providing a sufficiently high speed and high torque to meet the requirements of numbering applications.

The overall reduction factor between the output of the electric motor 15 and the corresponding numbering wheel 7 is selected to be such that a positional resolution (or accuracy) of the numbering wheel 7, measured at its periphery, is of the order of 0.10-0.15 mm or less, in order to ensure a sufficiently fine adjustment of the position of the numbering wheels 7. For numbering wheels 7 having typical diameters of the order of 20 to 30 mm, this implies a resolution of several hundreds steps per turn (i.e. less than 1° angular resolution). For a given type of motor that is adapted to take, e.g. six different positions per revolution (such as Maxon's EC 6 motor), this yields an overall reduction factor in the range of one hundred, which reduction factor can easily be attained by the combination of the reduction gear 18 and the gearing 16, 19-23 mentioned hereinabove.

One will not further describe the configuration of the above numbering device, which configuration forms the subject-matter of European patent application No. 06115994.3, the entire disclosure thereof being incorporated herein by reference. For the purpose of the present invention, it suffice to understand that, as mentioned in the preamble, a particularity of the numbering device disclosed in European patent application No. 06115994.3 resides in that each numbering wheel of the numbering device is driven into rotation by its own independent drive mechanism and can be set to any desired position independently from the other numbering wheels. This particularity requires that the position of the numbering wheels be controlled during actuation so as to ensure that the wheels are moved to the appropriate target positions before the subsequent numbering iteration. A wholly new control and actuation approach had to be conceived for this purpose, which approach will now be described.

From the foregoing, one will understand that, during actuation of the numbering wheels 7, friction will occur between neighbouring numbering wheels 7. As a consequence, each actuated numbering wheels will have a tendency to modify the position of the neighbouring wheels. According to the invention, such tendency is prevented by electronically regulating the position of each numbering wheel 7 which is not rotated or which has reached its new target position, at least during actuation of the numbering wheels 7, so as to compensate for these external factors acting on the numbering wheels 7. An electronic regulation unit is thus provided to carry out this compensation and regulation of the position of the numbering wheels 7, which electronic regulation unit can advantageously be implemented in a so-called Field Programmable Gate Array (FPGA).

Within the scope of the present invention, a solution for performing such electronic regulation might consist in acting directly on the electric motor 15 driving each numbering wheel 7 so as to create a high braking or holding torque preventing movement of the associated numbering wheel away from the desired target position. While possible in the context of the present invention, this solution is however not preferred as it necessitates a high current, and therefore a strong power supply. Furthermore, this would cause thermal problems as energy dissipations increase with current consumption. This solution might also lead to oscillation problems.

Preferably, the electronic regulation of the position of the numbering wheels 7 is performed by monitoring the position of the numbering wheel 7 and correcting the position thereof to return the wheel to its desired target position. In other words, rather than preventing any displacement of the numbering wheel 7 by applying a high holding torque, the numbering wheel 7 is allowed to move and its position is then corrected to return to the target position. This enables a reduction of power consumption as compared to the previous solution mentioned above since no current is applied to the electric motor 15 when in the target position, and therefore heat problems are avoided.

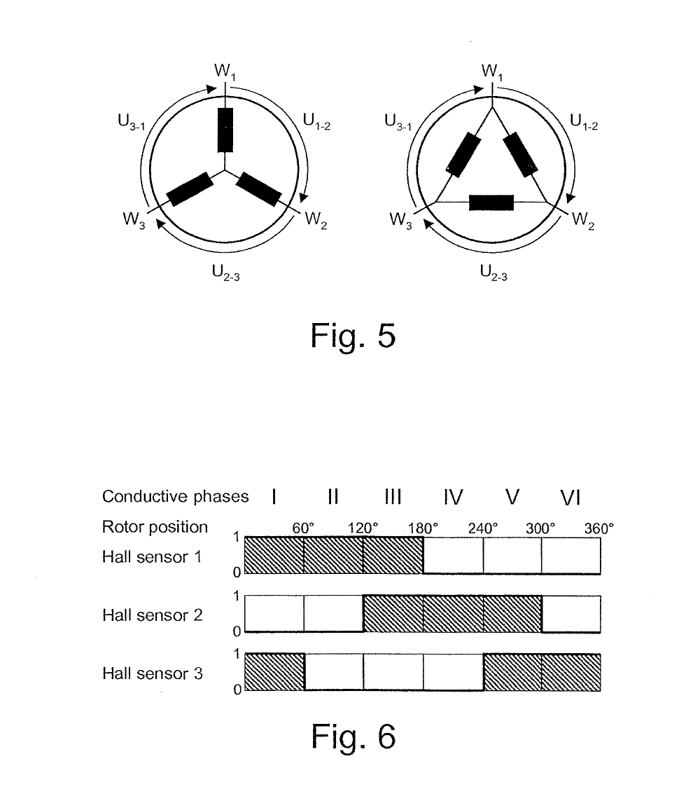

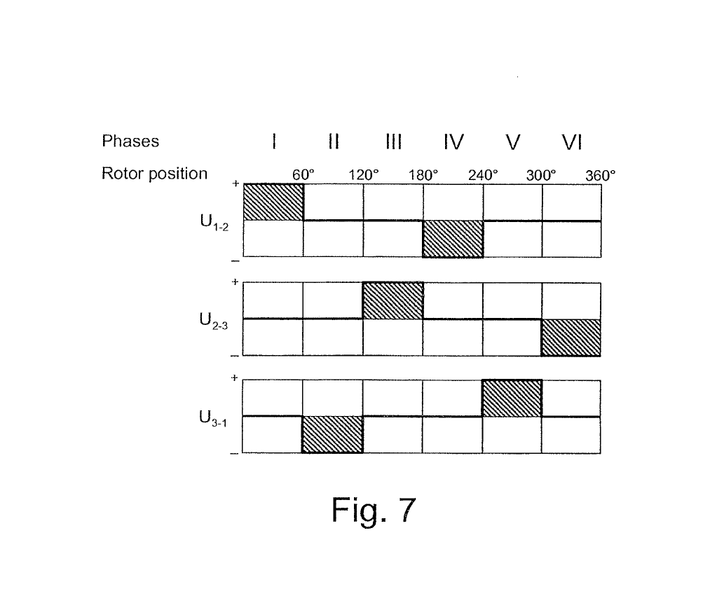

Monitoring of the position of the numbering wheel 7 is performed by directly monitoring the position of the motor 15. In that respect, the above-mentioned Maxon EC 6 motor is provided with integrated sensors (or monitoring means) to monitor the position of the rotor. More precisely, the rotor position is reported by three built-in Hall sensors which are arranged one with respect to the other with an offset of 120°, thereby providing six different switch combinations per revolution as shown schematically in FIG. 6. The winding arrangement on the stator side is a rhombic winding divided into three partial winding each shifted by 120°, which can either be connected in a “Y-circuit” or “Δ-circuit” as illustrated in FIG. 5 and which are supplied according to the diagram of FIG. 7. With a two-pole permanent magnet on the rotor side, this yields a motor having six possible positions per revolutions, which will be referred to in the following by the term “steps”.

According to one possible implementation of the driving means mentioned hereinabove, the overall reduction factor R between the output of the motor 15 and the associated numbering wheel 7 is selected to be equal to 108 (which value is only mentioned for the purpose of illustration and shall not be regarded as being limiting), which yields a resolution of 648 (=6×108) steps per revolution for the numbering wheel 7. Let us assume that the numbering wheel 7 comprises twelve numbering segments distributed uniformly on the circumference of the numbering wheel (i.e. one numbering segment every 30°), a skip from one numbering segment to its direct neighbour corresponds to 54 (=648/12) steps. Expressed in more general terms, this means that, for a given numbering wheel configuration with s numbering segments, the number of steps required for a numbering wheel 7 to reach its target position from its current position is a multiple of a given number of steps S_{U} (54 steps in the above example) corresponding to an angular displacement of the numbering wheel of 360°/s.

An advantage of the above-discussed numbering device configuration resides in that each numbering wheel can be rotated in any desired direction. Accordingly, any one of the numbering positions of the numbering wheels can be reached within a rotating angle of 180° or less. The control method is thus preferably conceived in such a way that it further comprises the step of determining, for each numbering wheel 7 to be actuated, a shortest way to the target position, which shortest way corresponds to an angular displacement of the numbering wheel 7 of 180° or less.

Referring again to the above example of a twelve-segment numbering wheel, this means that the number of actuation steps of the numbering wheel will be n times S_{U}, where n is an integer between 0 and 6. The required numbered of actuation steps to rotate a numbering wheel from its current position to its desired target position can thus be summarized in a simple lookup table of the type mentioned below where values ±n (n=0, 1, 2, . . . 6) indicate the multiple of times S_{U} steps have to be performed to reach the target position:

| | TARGET POSITION | | | | | | | | | | | |
|---|---|---|---|---|---|---|---|---|---|---|---|---|
| | SEG. | SEG. | SEG. | SEG. | SEG. | SEG. | SEG. | SEG. | SEG. | SEG. | SEG. | SEG. |
| CURRENT | 1 | 2 | 3 | 4 | 5 | 6 | 7 | 8 | 9 | 10 | 11 | 12 |
| POSITION | (“0”) | (“1”) | (“2”) | (“3”) | (“4”) | (“5”) | (“6”) | (“7”) | (“8”) | (“9”) | (“ [symbol] ”) | (“ [symbol] ”) |
| SEG. 1 (e.g. “0”) | 0 | +1 | +2 | +3 | +4 | +5 | ±6 | −5 | −4 | −3 | −2 | −1 |
| SEG. 2 (e.g. “1”) | −1 | 0 | +1 | +2 | +3 | +4 | +5 | ±6 | −5 | −4 | −3 | −2 |
| SEG. 3 (e.g. “2”) | −2 | −1 | 0 | +1 | +2 | +3 | +4 | +5 | ±6 | −5 | −4 | −3 |
| SEG. 4 (e.g. “3”) | −3 | −2 | −1 | 0 | +1 | +2 | +3 | +4 | +5 | ±6 | −5 | −4 |
| SEG. 5 (e.g. “4”) | −4 | −3 | −2 | −1 | 0 | +1 | +2 | +3 | +4 | +5 | ±6 | −5 |
| SEG. 6 (e.g. “5”) | −5 | −4 | −3 | −2 | −1 | 0 | +1 | +2 | +3 | +4 | +5 | ±6 |
| SEG. 7 (e.g. “6”) | ±6 | −5 | −4 | −3 | −2 | −1 | 0 | +1 | +2 | +3 | +4 | +5 |
| SEG. 8 (e.g. “7”) | +5 | ±6 | −5 | −4 | −3 | −2 | −1 | 0 | +1 | +2 | +3 | +4 |
| SEG. 9 (e.g. “8”) | +4 | +5 | ±6 | −5 | −4 | −3 | −2 | −1 | 0 | +1 | +2 | +3 |
| SEG. 10 (e.g. “9”) | +3 | +4 | +5 | ±6 | −5 | −4 | −3 | −2 | −1 | 0 | +1 | +2 |
| SEG. 11 (e.g. “ [symbol] ”) | +2 | +3 | +4 | +5 | ±6 | −5 | −4 | −3 | −2 | −1 | 0 | +1 |
| SEG. 12 (e.g. “ [symbol] ”) | +1 | +2 | +3 | +4 | +5 | ±6 | −5 | −4 | −3 | −2 | −1 | 0 |

For example, let us assume the current position of the numbering wheel is on numbering segment 8 (for instance for printing numeral “7”) and that this numbering wheel has to be rotated to numbering segment 11 (for instance for printing a cancellation mark [symbol] ), the numbering wheel has to be actuated for n=3 times S_{U} steps in the positive direction, i.e. for a total of 162 steps in the above numerical example where S_{U}=54 steps.

In this example, once the motor 15 has performed 162 steps in the positive direction (i.e. 27 revolutions in this example), the associated numbering wheel will have reached its target position. Upon reaching this target position, the position of the motor 15 is monitored using the built-in Hall sensors. If one or more steps in the positive or negative direction are detected (which steps could be induced by external factors, such as friction with a neighbouring rotating numbering wheel), the motor 15 is actuated in order to return the numbering wheel 7 to its target position by “adding” or “subtracting” the adequate number of corrective steps.

Besides the above correction principle, the numbering wheels have to be actuated in such a way as to ensure as quick as possible a rotation of the numbering wheels to their desired target positions. In this context, the fact that each numbering wheel can be actuated in two directions, as mentioned hereinabove, is beneficial in that each numbering wheel needs to be rotated for an angle of maximum 180° in the “worst” case:

In practice, a numbering press is designed to operate at a speed of several thousands sheets per hour (sph), typically of the order of 10,000 sph. Let us for instance take the case of a machine working at 12,000 sph. At such speed, each numbering cylinder on which the numbering devices are mounted performs a complete revolution in 0.3 seconds. During each revolution, each numbering device has to be actuated, inked and then brought in contact with the documents to be numbered. This means in practice that the actuation time for each numbering device is limited to approximately 100 to 120 milliseconds.

Based on the above considerations, the mean rotational speed of each numbering wheel 7 must at least be of the order of 250 rpm, which means that the electric motor 15 must be capable of reaching at least 27,000 rpm due to the reduction factor existing between the electric motor 15 and the associated numbering wheel 7 (27,000 rpm=108×250 rpm). In this context, Maxon's motors and planetary gears are perfectly suited to this application as Maxon's EC 6 motor coupled to Maxon's GP 6 planetary gearhead is capable of reaching approximately 40,000 rpm.

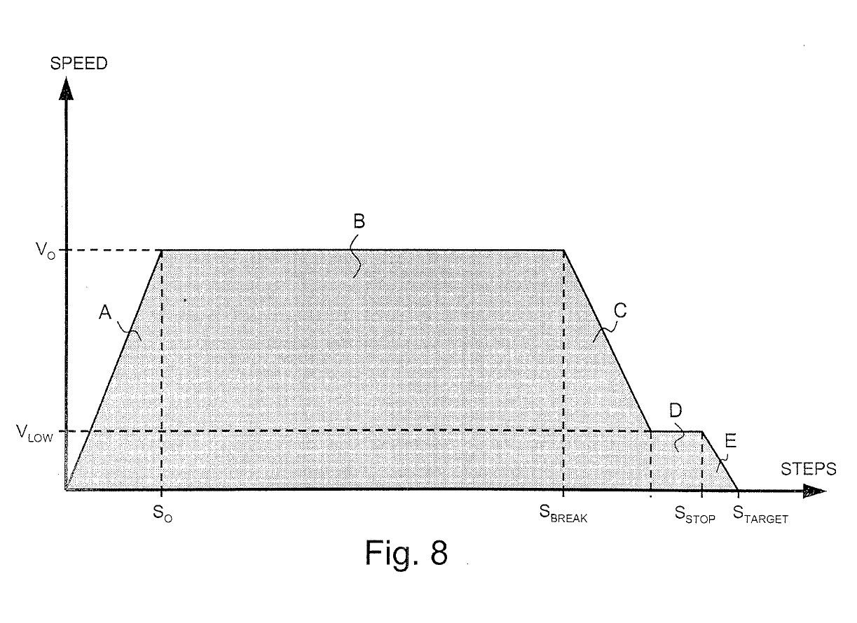

FIG. 8 is a schematic diagram illustrating a preferred multi-phase actuation principle that is followed in order to rotate the numbering wheels 7 to their intended target positions. In FIG. 8, the horizontal axis represents the number of actuation steps of the motor 15, while the vertical axis represents the speed thereof (it being understood that the associated numbering wheel follows the same actuation profile as a consequence).

Generally speaking, actuation of the numbering wheels 7 can be decomposed in three successive phases, namely (i) a first phase A during which an actuated numbering wheel is accelerated, (ii) as second phase B during which the actuated numbering wheel is driven at a substantially constant speed, and (iii) a third phase C during which the actuated numbering wheel is decelerated before reaching the intended target position.

During the first phase, the actuated numbering wheel 7 is accelerated by bringing the associated electric motor 15 to a target speed V_{O} (or until a determined number of actuation steps S_{O} have been reached). Thereafter, the electric motor is run at substantially constant speed during phase B until a predetermined number of remaining steps S_{BREAK} are left before reaching the target number of steps S_{TARGET}. From this point, the electric motor (and associated numbering wheel) is decelerated.

It is in practice difficult to simply decelerate the electric motor so that the associated numbering wheel comes to complete standstill exactly at the desired target position. Indeed, due to the high rotation speed of the motor and inherent measurement tolerances, there is always a risk that complete standstill of the numbering wheel will occur a couple of steps before or after the desired target position has been reached, which then requires a final correction step to “add” or “subtract” the appropriate number of corrective steps.

Accordingly, actuation of the numbering wheels preferably further comprises (iv) a fourth phase D during which the actuated numbering wheel is driven at a low speed until determined actuation parameters preceding complete standstill of the actuated numbering wheel are reached, and (v) a fifth phase E during which the actuated numbering wheel is brought to complete standstill according to a. predetermined deceleration sequence.

According to this preferred actuation principle, the electric motor (and associated numbering wheel) is decelerated during phase C until a minimum speed V_{LOW} has been reached (for instance of the order of 1500 rpm) and, thereupon, is driven at the minimum speed V_{LOW} during phase D until a fixed number of steps S_{STOP} before the target number of steps S_{TARGET} is reached. Minimum speed V_{LOW} is the same for all electric motors and, at the end of phase D, the speed and number of steps still to run are known.

In other words, at the end of phase D, estimation of the motor parameters for the final deceleration phase E is possible and can be pre-computed and stored in a lookup table. During phase E, the commutation rate of the electric motors driving the actuated numbering wheels is thus reduced according to a predetermined deceleration sequence until complete standstill is achieved at the desired target position (i.e. when target number of steps S_{TARGET} is reached)

As mentioned hereinabove, upon reaching the target position, electronic regulation of the position of the numbering wheel is activated so as to prevent that external factors, in particular friction from neighbouring rotating numbering wheels, cause a change of the position of the numbering wheel.

As already discussed hereinabove, the numbering device is preferably provided with calibration means comprising for instance at least a magnet disposed on each numbering wheel 7 and a corresponding sensor 13 for detecting passage of said at least one magnet. These calibration means are used for periodically calibrating a reference position of each numbering wheel 7 so as to ensure proper correspondence between the actual position of each numbering wheel 7 and the measurements made at the level of the associated electric motor 15.

One will now turn to FIGS. 4a to 4c which schematically illustrate an embodiment of a releasable indexing mechanism for mechanically aligning and maintaining the position of the numbering wheels during a numbering operation (which variant also forms the subject-matter of European patent application No. 06115994.3). This indexing mechanism enables to guarantee, if necessary, an exact positioning of the numbering wheels 7 on their target positions. It shall be understood that this indexing mechanism is only activated once all the numbering wheels have been rotated to their target positions. Further embodiments of such a releasable indexing mechanism are described in European patent application No. 06124403.4 and PCT application No. PCT/IB2007/052366 already mentioned hereinabove).

The releasable indexing mechanism operates basically by pushing a movable indexing member 50 extending parallel to the axis of rotation of the numbering wheels 7 against indexing grooves 7a provided on the numbering wheels 7. According to the variant of FIGS. 4a to 4c, the indexing member 50 cooperates with the inner circumference of the numbering wheels 7 where inner indexing grooves 7a are provided. Other variants might be envisaged, for instance an indexing mechanism comprising an indexing member which cooperates with outer indexing grooves provided between the numbering symbols on the outer circumference of the numbering wheels 7.

In the variant of FIGS. 4a to 4c, the indexing member 50 is integrated within the common shaft 17 and extends axially along the periphery of the common shaft 17. This indexing member 50 is pulled away from the inner indexing grooves 7a during actuation of the numbering wheels 7 (see FIG. 4b) and pushed against these indexing grooves 7a upon completion of the actuation process (see FIG. 4a).

The indexing member is preferably actuated using an electromagnetic actuation system comprising, for instance, a static energizing coil (not illustrated) located within the common shaft 17 and which surrounds the indexing member 50 so as to push or pull this member into or out of the indexing grooves 7a. Preferably, a coil current creating a variable reluctance force is supplied to the energizing coil to move up the indexing member 50 and thereby release the numbering wheels 7. The indexing member 50 is preferably brought to its default position (i.e. the position wherein the indexing member 50 is pushed into the indexing grooves 7a) by means of springs (such as leaf springs) placed between the indexing member 50 and the shaft 17.

Within the scope of the present invention, the above-described indexing mechanism would be actuated in order to mechanically lock the position of all numbering wheels once all the actuated numbering wheels have reached their target positions. Upon actuation of the indexing mechanism, the electronic regulation of the position of the numbering wheels described hereinabove is stopped, until a subsequent actuation of the numbering wheels is performed. The mechanical indexing mechanism is advantageously activated at least during a printing operation, and preferably during a preceding inking operation of the numbering wheels as well.

It will be understood that various modifications and/or improvements obvious to the person skilled in the art can be made to the embodiments described hereinabove without departing from the scope of the invention defined by the annexed claims. For instance, while a mechanical indexing mechanism is preferred, such mechanism is not as such required and the position of the numbering wheels could be controlled during printing and/or inking solely by the above-described electronic regulation process.

1. A method for controlling the position of numbering wheels of a numbering device, which numbering device is of the type comprising a plurality of independently-driven numbering wheels disposed adjacent to one another for rotation about a common rotation axis, the method comprising actuating the numbering wheels between successive numbering iterations, whereby each numbering wheel which has to be rotated to a new target position is driven into rotation until it reaches its new target position,
wherein said method further comprises, at least during actuation of the numbering wheels, compensating for external factors acting on the numbering wheels by electronically regulating the position of each numbering wheel which is not rotated or which has reached its new target position.

2. The method according to claim 1, wherein said electronic regulation of the position of each numbering wheel includes monitoring the position of the numbering wheel and correcting the position of the numbering wheel to return to its desired position.

3. The method according to claim 2, wherein monitoring of the position of the numbering wheel is performed by monitoring the position of an associated electric motor driving said numbering wheel.

4. The method according to claim 1, wherein said actuation of the numbering wheels includes:
a first phase during which an actuated numbering wheel is accelerated;
a second phase during which the actuated numbering wheel is driven at a substantially constant speed; and
a third phase during which the actuated numbering wheel is decelerated before reaching the target position.

5. The method according to claim 4, wherein actuation of the numbering wheels further includes:
a fourth phase during which the actuated numbering wheel is driven at a low speed until determined actuation parameters preceding complete standstill of the actuated numbering wheel are reached; and
a fifth phase during which the actuated numbering wheel is brought to complete standstill according to a predetermined deceleration sequence.

6. The method according to claim 1, wherein each numbering wheel is driven into rotation by an electric motor having a plurality of steps per revolution and wherein actuation of a numbering wheel to a target position comprises:
determining a number of steps required for the numbering wheel to reach the target position from its current position; and
driving the numbering wheel into rotation for the determined number of steps.

7. The method according to claim 6, wherein, for a given numbering wheel configuration with s numbering segments, the number of steps required for the numbering wheel to reach the target position from its current position is a multiple of a given number of steps corresponding to an angular displacement of the numbering wheel of 360°/s.

8. The method according to claim 6, wherein each numbering wheel is driven by said electric motor through a gearing with a reduction factor.

9. The method according to claim 3, wherein said motor is a brush-less DC motor with electronic commutation.

10. The method according to claim 1, comprising the step of determining, for each numbering wheel to be actuated, a shortest way to the target position, which shortest way corresponds to an angular displacement of the numbering wheel of 180° or less.

11. The method according to claim 1, further comprising periodically calibrating a reference position of said numbering wheels.

12. The method according to claim 1, further comprising, once all actuated numbering wheels have reached their target positions, actuating a mechanical indexing mechanism for mechanically locking the position of all numbering wheels and stopping the electronic regulation of the position of the numbering wheels until a subsequent actuation of the numbering wheels.

13. The method according to claim 12, wherein said mechanical indexing mechanism is activated at least during a printing operation and, preferably, during an inking operation of the numbering wheels.

14. A device for controlling the position of numbering wheels of a numbering device, which numbering device is of the type comprising a plurality of independently-driven numbering wheels disposed adjacent to one another for rotation about a common rotation axis, said device comprising actuation means for actuating the numbering wheels of the numbering device between successive numbering iterations, whereby each numbering wheel which has to be rotated to a new target position is driven into rotation until it reaches its new target position,
wherein said device further comprises an electronic regulation unit for compensating for external factors acting on the numbering wheels, at least during actuation of the numbering wheels, by electronically regulating the position of each numbering wheel which is not rotated or which has reached its new target position.

15. The device according to claim 14, further comprising monitoring means for monitoring the position of each numbering wheel and wherein said electronic regulation unit is adapted to correct the position of each numbering wheel to return to its desired position.

16. The device according to claim 15, wherein said monitoring means monitor the position of an associated electric motor driving said numbering wheel.

17. The device according to claim 14, wherein said actuation means comprise electric motors for driving the numbering wheels into rotation.

18. The device according to claim 17, wherein said electric motors are brush-less DC motors with electronic commutation.

19. The device according to claim 17, wherein each numbering wheel is driven by a corresponding one of said electric motors through a gearing with a reduction factor.

20. The device according to claim 14, further comprising calibration means for periodically calibrating a reference position of said numbering wheels.

21. The device according to claim 14, further comprising a mechanical indexing mechanism for mechanically locking the position of all numbering wheels once all actuated numbering wheels have reached their target positions.

22. The device according to claim 14, wherein said electronic regulation unit is implemented in a Field Programmable Gate Array (FPGA).

23. The device according to claim 14, wherein said actuation means actuate the numbering wheels according to the methods of claim 4.

24. The device according to claim 14, wherein said actuation means actuate the numbering wheels according to the method of claim 6.

25. The method according to claim 6, wherein said motor is a brush-less DC motor with electronic commutation.
